(19) United States
(12) Patent Application Publication
(10) Pub. No.: US 2015/0103069 A1
(43) Pub. Date: Apr. 16, 2015

(54) ARRAY SUBSTRATE, 3D DISPLAY DEVICE AND DRIVING METHOD FOR THE SAME

(71) Applicants: BEIJING BOE DISPLAY TECHNOLOGY CO., LTD., Beijing (CN); BOE TECHNOLOGY GROUP CO., LTD., Beijing (CN)

(72) Inventors: Liang ZHANG, Beijing (CN); Xibin SHAO, Beijing (CN); Dan WANG, Beijing (CN); Weihao HU, Beijing (CN); Yizhen XU, Beijing (CN); Shuai HOU, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 14/100,719

(22) Filed: Dec. 9, 2013

(30) Foreign Application Priority Data
Dec. 10, 2012 (CN) 201210528324.3

(51) Int. Cl. G09G 3/00

(52) U.S. Cl. CPC G09G 3/001; G09G 2380/00; G09G 2300/08; G09G 2300/0426; G09G 2310/0267; G09G 2310/062
USPC 345/214

(57) ABSTRACT

The present invention provides an array substrate, a 3D display device and a driving method for the same, and belongs to the field of 3D display. Wherein, the array substrate comprises: a substrate, and 2n rows of pixel units being arranged on the substrate in a matrix form, the array substrate further comprises gate lines corresponding to the pixel units in each row, and each of the gate lines is connected to the gate electrodes of thin film transistors in corresponding pixel units, wherein the gate line corresponding to pixel units in the (2k−1)^{th} row of pixel units or the gate line corresponding to the 2k^{th} row receives the gate scanning signal in a predetermined time period, wherein k is a natural number which is not less than 1 and not greater than n.

### CROSS REFERENCE

The present application claims a priority of the Chinese patent application No. 201210528324.3 filed on Dec. 10, 2013, which is incorporated herein by reference in its entirety.

### TECHNICAL FIELD

The present invention relates to a field of 3D display, in particular to an array substrate, a 3D display device and a driving method for the same.

### BACKGROUND

With the development of displaying technology, the 3D display technology has become one of the important technologies for the display device. The active shutter 3D display technology may implement the 3D displaying with low cost, wherein the 3D effect is achieved by improving the refresh rate of the picture, and both eyes of a viewer may see the corresponding images for the left eye and the right eye respectively by the fast switching of the 3D glasses, so that the effect of dimensional images is achieved.

Due to the requirements of human eyes on the reception of continuous images, it is required to provide an image with a refresh rate of at least 60 Hz for each eye. So, the display device must have a refresh rate up to 120 Hz, and correspondingly a driving frequency for a driving circuit of the display device needs to be increased to 120 Hz too, which results in a decrease in the charging time for each pixel electrode. In order to ensure a charging rate for the pixel electrode, usually it needs to add a line width in the display device, thereby to reduce a load of the display device. However, this will reduce the transmittance of the display device. In addition, the yield of the display devices with a high refresh rate is low, and as a result the production cost will be increased.

### SUMMARY

An object of the present invention is to provide an array substrate, a 3D display device and a driving method for the same, so as to ensure a charging time for a pixel electrode while increasing a refresh rate of the display device, thereby to achieve 3D display.

In one aspect, embodiments the present invention provide an array substrate, including: a substrate, and 2n rows of pixel units arranged on the substrate in a matrix form, the array substrate further comprises gate lines each of which corresponds to the pixel units in each row, and each of the gate lines is connected to the gate electrodes of thin film transistors in corresponding pixel units, wherein the gate line corresponding to pixel units in the (2k−1)^{th} row or the gate line corresponding to pixel units in the 2k^{th} row receives the gate scanning signal in a predetermined time period, wherein n is a natural number and k is a natural number which is not less than 1 and not greater than n.

Furthermore, in the above solution, the gate lines corresponding to pixel units in the 1^{st} row, the 3^{rd} row, . . . , the (2k−1)^{th} row, . . . , the (2n−1)^{th} row receives the gate scanning signal sequentially in the predetermined time period; and the gate lines corresponding to pixel units in the 2^{nd} row, the 4^{th} row, . . . , the 2k^{th} row, . . . , the 2n^{th} row do not receive the gate scanning signal in the predetermined time period.

Furthermore, in the above solution, the gate lines corresponding to pixel units in the 2^{nd} row, the 4^{th} row, . . . , the 2k^{th} row, . . . , the 2n^{th} row receive the gate scanning signal sequentially in the predetermined time period; and the gate lines corresponding to pixel units in the 1^{st} row, the 3^{rd} row, . . . , the (2k−1)^{th} row, . . . , the (2n−1)^{th} row do not receive the gate scanning signal in the predetermined time period.

Furthermore, in the above solution, a time length of the predetermined time period is within a range of 1/480˜1/120 s.

Embodiment of the present invention also provide a 3D display device, including the array substrate as described above and a drive circuit, the driving circuit comprises:

a gate driving circuit, configured to provide the gate scanning signal to the gate line corresponding to pixel units in the (2k−1)^{th} row in the predetermined time period; or provide the gate scanning signal to the gate line corresponding to pixel units in the 2k^{th} row in the predetermined time period.

Furthermore, in the above solution, the gate lines corresponding to pixel units in the 1^{st} row, the 3^{rd} row, . . . , the (2k−1)^{th} row, . . . , the (2n−1)^{th} row receive the gate scanning signal sequentially in the predetermined time period; and the gate lines corresponding to pixel units in the 2^{nd} row, the 4^{th} row, . . . , the 2k^{th} row, . . . , the 2n^{th} row do not receive the gate scanning signal in the predetermined time period.

Furthermore, in the above solution, the gate lines corresponding to pixel units in the 2^{nd} row, the 4^{th} row, . . . , the 2k^{th} row, . . . , the 2n^{th} row receive the gate scanning signal sequentially in the predetermined time period; and the gate lines corresponding to pixel units in the 1^{st} row, the 3^{rd} row, . . . , the (2k−1)^{th} row, . . . , the (2n−1)^{th} row do not receive the gate scanning signal in the predetermined time period.

Furthermore, in the above solution, a time length of the predetermined time period is within a range of 1/480˜1/120 s.

Embodiments of the present invention also provide a driving method for the 3D display device as described above, and the driving method may comprise:

transmitting the gate scanning signal to the gate line corresponding to pixel units in the (2k−1)^{th} row in the predetermined time period; or

transmitting the gate scanning signal to a gate line corresponding to pixel units in the 2k^{th} row in the predetermined time period.

Furthermore, in the above solution, transmitting the gate scanning signal to a gate line corresponding to pixel units in the (2k−1)^{th} row in the predetermined time period comprises:

transmitting the gate scanning signal to each of the gate lines corresponding to pixel units in the 1^{st} row, the 3^{rd} row, . . . , the (2k−1)^{th} row, . . . , the (2n−1)^{th} row sequentially in the predetermined time period; not transmitting the gate scanning signal to the gate lines corresponding to pixel units in the 2^{nd} row, the 4^{th} row, . . . , the 2k^{th} row, . . . , the 2n^{th} row sequentially in the predetermined time period.

Furthermore, in the above solution, transmitting the gate scanning signal to a gate line corresponding to pixel units in the 2k^{th} row in the predetermined time period comprises:

transmitting the gate scanning signal to each of the gate lines corresponding to pixel units in the 2^{nd} row, the 4^{th} row, . . . , the 2k^{th} row, . . . , the 2n^{th} row sequentially in the predetermined time period; not transmitting the gate scanning signal to the gate lines corresponding to pixel units in the 1^{st} row, the 3^{rd} row, . . . , the (2k−1)^{th} row, . . . , the (2n−1)^{th} row sequentially in the predetermined time period.

Furthermore, in the above solution, wherein a time length of the predetermined time period is within a range of 1/480˜1/120 s.

Embodiments of the present invention have the following beneficial effect.

In the above solutions, the gate lines of the array substrate receive the gate scanning signal in the predetermined time period, wherein only the gate lines of pixel units in odd-numbered rows are receiving the gate scanning signal in the predetermined time period, or only the gate lines of pixel units in even-numbered rows are receiving the gate scanning signal in the predetermined time period. Thus, in the technical solution of the present invention, only the gate electrodes of half of the pixel units are required to be charged in one image frame, which may reduce the charging time of the array substrate. It may improve the refresh rate of the display device while ensuring the charging time of the pixel electrodes and implementing 3D displaying.

### BRIEF DESCRIPTION OF THE DRAWINGS

FIG. 1 illustrates a schematic view for displaying by a 3D display device according to the first embodiment of the present invention;

FIG. 2 illustrates a schematic view for displaying by a 3D display device according to the second embodiment of the present invention.

### DETAILED DESCRIPTION

To make the objects, the technical solutions and the advantages of the present invention to be more apparent, the present invention is described hereinafter in conjunction with the drawings and the embodiments.

Embodiments the present invention provide an array substrate, a 3D display device and a driving method for the same, so as to ensure a charging time for a pixel electrode while increasing a refresh rate of the display device, thereby to achieve 3D display.

According to embodiments of the present invention, gate lines of the array substrate receive a gate scanning signal in a predetermined time period, wherein only the gate lines of pixel units in odd-numbered rows receive the gate scanning signal in the predetermined time period, or only the gate lines of pixel units in even-numbered rows receive the gate scanning signal in the predetermined time period. Thus, in the embodiments of the present invention, only the gate electrodes of half of the pixel units are required to be charged in a image frame, which may reduce the charging time of the array substrate. It may ensure a charging time for a pixel electrode while increasing a refresh rate of the display device, thereby to achieve 3D display.

In the following, the array substrate, the 3D display device and the driving method for the same according to the present invention will be described in detail in conjunction with the drawings and the embodiments.

### The First Embodiment

A refresh rate of a display device may be within a range of 60˜240 Hz. When the refresh rate of the display device is 60 Hz and it is assumed that 1126 rows of pixel units are arranged on the array substrate, the opening time for the pixel units in each row is 1/(1126*60) s (approximately 14.8 us) if being scanned row by row. In order to achieve 3D display, it is required to increase the refresh rate of the display device to 120 Hz, which however results in a decrease in the charging time for a pixel electrode. To ensure a charging rate of the pixel electrode, usually it needs in the prior art to add a line width of the array substrate, thereby to reduce a load of the display device. However, this will reduce the transmittance of the display device. In addition, the display device with a high refresh rate will have poor image quality due to the insufficient response time.

In order to solve the above problems, this embodiment provides an array substrate, including: a substrate, and 2n rows of pixel units being arranged on the substrate in a matrix form. The array substrate may further comprise gate lines each of which corresponds to the pixel units in each row, and each of the gate lines is connected to the gate electrodes of thin film transistors in the corresponding pixel units, wherein the gate line corresponding to pixel units in the (2k−1)^{th} row receives a gate scanning signal in a predetermined time period, wherein n is a natural number and k is a natural number which is not less than 1 and not greater than n.

Furthermore, in this embodiment, the gate lines corresponding to pixel units in the 1^{st} row, the 3^{rd} row, . . . , the (2k−1)^{th} row, . . . , the ((2n−1))^{th} row receive the gate scanning signal sequentially in the predetermined time period; and the gate lines corresponding to pixel units in the 2^{nd} row, the 4^{th} row, . . . , the 2k^{th} row, . . . , the 2n^{th} row do not receive the gate scanning signal in the predetermined time period.

Furthermore, in this embodiment, a time length of the predetermined time period may be within a range of 1/480˜1/120 s.

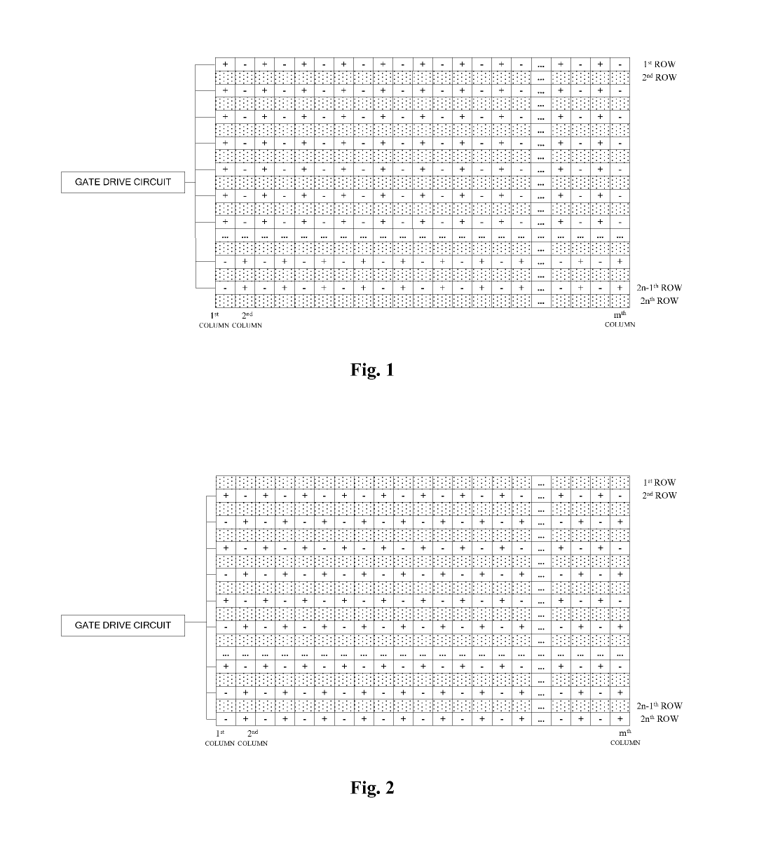

This embodiment also provides a 3D display device, including the array substrate as described above and a drive circuit, and as illustrated in FIG. 1, the driving circuit comprises: a gate driving circuit, configured to provide the gate scanning signal to a gate line corresponding to pixel units in the (2k−1)^{th} row in the predetermined time period.

In this embodiment, the display device may be a liquid crystal display, a liquid crystal TV, an OLED display, an OLED TV, an electronic paper, a mobile phone, a tablet PC, or etc.

In this embodiment, it is also provided a method for driving the 3D display device as described above, and the method may comprise:

transmitting the gate scanning signal to a gate line corresponding to the pixel units in the (2k−1)^{th} row in the predetermined time period.

Specifically, when the image is provided to the left eye of the viewer by the switch of the active shutter glasses, the gate driving circuit transmits the gate scanning signal to the gate lines corresponding to pixel units in the 1^{st} row, the 3^{rd} row, . . . , the (2k−1)^{th} row, . . . , the (2n−1)^{th} row sequentially, the gate lines corresponding to pixel units in the 1^{st} row, the 3^{rd} row, . . . , the (2k−1)^{th} row, . . . , the (2n−1)^{th} row receive the gate scanning signal sequentially, and thus the image display for the left eye is achieved; the gate driving circuit does not transmit the gate scanning signal to the gate lines corresponding to pixel units in the 2^{nd} row, the 4^{th} row, . . . , the 2k^{th} row, . . . , the 2n^{th} row, and the gate lines corresponding to pixel units in the 2^{nd} row, the 4^{th} row, . . . , the 2k^{th} row, . . . , the 2n^{th} row do not receive the gate scanning signal, and the pixel units in even-numbered rows will be displayed in black, i.e. shadow regions as shown in FIG. 1.

Similarly, when the image is provided to the right eye of the viewer by the switch of the active shutter glasses, the gate driving circuit transmits the gate scanning signal to the gate lines corresponding to pixel units in the 1^{st} row, the 3^{rd} row, . . . , the (2k−1)^{th} row, . . . , the (2n−1)^{th} row sequentially, the gate lines corresponding to pixel units in the 1^{st} row, the 3^{rd} row, . . . , the (2k−1)^{th} row, . . . , the (2n−1)^{th} row receive the gate scanning signal sequentially, and thus the image display for the right eye is achieved; the gate driving circuit does not transmit the gate scanning signal to the gate lines corresponding to pixel units in the 2^{nd} row, the 4^{th} row, . . . , the 2k^{th} row, . . . , the 2n^{th} row, and the gate lines corresponding to pixel units in the 2^{nd} row, the 4^{th} row, . . . , the 2k^{th} row, . . . , the 2n^{th} row do not receive the gate scanning signal, and the pixel units in even-numbered rows will be displayed in black, i.e. shadow regions as shown in FIG. 1.

In summary, in the process of displaying by the 3D display device in this embodiment, the gate driving circuit always does not transmit the gate scanning signal to the gate line of the pixel units in even-numbered rows, and the display of the pixel units in even-numbered rows is always in black. Meanwhile, in this process, the data drive circuit of the array substrate normally provides data signal to the data line of the pixel units, but the thin film transistor of the pixel units cannot be turned on when the gate scanning signal is not received by the gate line of the pixel units. Therefore, the pixel units may not display an image, and display in black.

According to the above embodiment, the 3D display device may refresh the image 120 times within 1 s, so that the refresh rate of the 3D display device reaches 120 Hz. If 1126 rows of the pixel units are arranged on the array substrate, the opening time for the pixel units in each row is (1/120)/(1126/2) s (approximately 14.8 us) if being scanned row by row. It can be seen that, in order to achieve 3D display, although the refresh rate of the 3D display device of embodiments the present invention is increased to 120 Hz, as twice as the original refresh rate, it is still able to ensure a sufficiently long charging time for the pixel electrode as well as a sufficiently long response time for the display device, thereby to ensure the image quality.

In this embodiment, only the gate electrodes of half of the pixel units are required to be charged in one image frame, which may reduce the charging time of the 3D display device, and may improve the refresh rate of the display device while ensuring the charging time of the pixel electrodes and implementing 3D displaying. Furthermore, when the pixel units in odd-numbered rows are displaying image, the pixel units in even-numbered rows display in black, which may reduce the crosstalk phenomenon of the 3D display.

### The Second Embodiment

A refresh rate of a display device may be within a range of 60˜240 Hz. When the refresh rate of the display device is 60 Hz and it is assumed that 1126 rows of pixel units are arranged on the array substrate, the opening time for the pixel units in each row is 1/(1126*60) s (approximately 14.8 us) if being scanned row by row. In order to achieve 3D display, it is required to increase the refresh rate of the display device to 120 Hz, which however results in a decrease in the charging time for a pixel electrode. To ensure a charging rate of the pixel electrode, usually it needs in the prior art to add a line width of the array substrate, thereby to reduce a load of the display device. However, this will reduce the transmittance of the display device. In addition, the display device with a high refresh rate will have poor image quality due to the insufficient response time.

In order to solve the above problems, this embodiment provides an array substrate, including: a substrate, and 2n rows of pixel units being arranged on the substrate in a matrix form. The array substrate may further comprise gate lines each of which corresponds to the pixel units in each row, and each of the gate lines is connected to the gate electrodes of thin film transistors in corresponding pixel units, wherein the gate line corresponding to pixel units in the 2k^{th} row receives a gate scanning signal in a predetermined time period, wherein n is a natural number and k is a natural number which is not less than 1 and not greater than n.

Furthermore, in this embodiment, the gate lines corresponding to pixel units in the 2^{nd} row, the 4^{th} row, . . . , the 2k^{th} row, . . . , the 2n^{th} row receive the gate scanning signal sequentially in the predetermined time period; and the gate lines corresponding to pixel units in the 1^{st} row, the 3^{rd} row, . . . , the (2k−1)^{th} row, . . . , the (2n−1)^{th} row do not receive the gate scanning signal in the predetermined time period.

Furthermore, in this embodiment, a time length of the predetermined time period may be within a range of 1/480˜1/120 s.

This embodiment also provides a 3D display device, including the array substrate as described above and a drive circuit, and as illustrated in FIG. 2, the driving circuit comprises:

a gate driving circuit, being configured to provide the gate scanning signal to a gate line corresponding to pixel units in the 2k^{th} row in the predetermined time period.

In this embodiment, the display device may be a liquid crystal display, a liquid crystal TV, an OLED display, an OLED TV, an electronic paper, a mobile phone, a tabletPC, or etc.

In this embodiment, it is also provided a driving method for the 3D display device as described above, and the driving method may comprise:

transmitting the gate scanning signal to a gate line corresponding to pixel units in the 2k^{th} row in the predetermined time period.

Specifically, when the image is provided to the left eye of the viewer by the switch of the active shutter glasses, the gate driving circuit transmits the gate scanning signal to the gate lines corresponding to pixel units in the 2^{nd} row, the 4^{th} row, . . . , the 2k^{th} row, . . . , the 2n^{th} row sequentially, the gate lines corresponding to pixel units in the 2^{nd} row, the 4^{th} row, . . . , the 2k^{th} row, . . . , the 2n^{th} row receive the gate scanning signal sequentially, and thus the image display for the left eye is achieved; the gate driving circuit does not transmit the gate scanning signal to the gate lines corresponding to pixel units in the 1^{st} row, the 3^{rd} row, . . . , the (2k−1)^{th} row, . . . , the (2n−1)^{th} row, and the gate lines corresponding to pixel units in the 1^{st} row, the 3^{rd} row, . . . , the (2k−1)^{th} row, . . . , the (2n−1)^{th} row do not receive the gate scanning signal, and the pixel units in odd-numbered rows will be displayed in black, i.e. shadow regions as shown in FIG. 2.

Similarly, when the image is provided to the right eye of the viewer by the switch of the active shutter glasses, the gate driving circuit transmits the gate scanning signal to the gate lines corresponding to pixel units in the 2^{nd} row, the 4^{th} row, . . . , the 2k^{th} row, . . . , the 2n^{th} row sequentially, the gate lines corresponding to pixel units in the 2^{nd} row, the 4^{th} row, . . . , the 2k^{th} row, . . . , the 2n^{th} row receive the gate scanning signal sequentially, and thus the image display for the right eye is achieved; the gate driving circuit does not transmit the gate scanning signal to the gate lines corresponding to pixel units in the 1^{st} row, the 3^{rd} row, . . . , the (2k−1)^{th} row, . . . , the (2n−1)^{th} row, and the gate lines corresponding to pixel units in the 1^{st} row, the 3^{rd} row, . . . , the (2k−1)^{th} row, . . . , the (2n−1)^{th} row do not receive the gate scanning signal, and the pixel units in odd-numbered rows will be displayed in black, i.e. shadow regions as shown in FIG. 2.

In summary, in the process of displaying by the 3D display device in this embodiment, the gate driving circuit always does not transmit the gate scanning signal to the gate line of the pixel units in odd-numbered rows, and the display of the pixel units in odd-numbered rows is always in black. Meanwhile, in this process, the data drive circuit of the array substrate normally provides data signal to the data line of the pixel units, but the thin film transistor of the pixel units cannot be turned on when the gate scanning signal is not received by the gate line of the pixel units. Therefore, the pixel units may not display an image, and display in black.

According to the above embodiment, the 3D display device may refresh the image 120 times within 1 s, so that the refresh rate of the 3D display device reaches 120 Hz. If 1126 rows of the pixel units are arranged on the array substrate, the opening time for the pixel units in each row is (1/120)/(1126/2) s (approximately 14.8 us) if being scanned row by row. It can be seen that, in order to achieve 3D display, although the refresh rate of the 3D display device of embodiments the present invention is increased to 120 Hz, as twice as the original refresh rate, it is still able to ensure a sufficiently long charging time for the pixel electrode as well as a sufficiently long response time for the display device, thereby to ensure the image quality.

In this embodiment, only the gate electrodes of half of the pixel units are required to be charged in one image frame, which may reduce the charging time of the 3D display device, and may improve the refresh rate of the display device while ensuring the charging time of the pixel electrodes and implementing 3D displaying. Furthermore, when the pixel units in even-numbered rows are displaying image, the pixel units in odd-numbered rows display in black, which may reduce the crosstalk phenomenon of the 3D display.

The above are merely the preferred embodiments of the present invention. It should be noted that, a person skilled in the art may further make improvements and modifications without departing from the principle of the present invention, and these improvements and modifications shall also be considered as the scope of the present invention.

What is claimed is:

1. An array substrate, including: a substrate, and 2n rows of pixel units arranged on the substrate in a matrix form, the array substrate further comprises gate lines each of which corresponds to the pixel units in each row, and each of the gate lines is connected to the gate electrodes of thin film transistors in corresponding pixel units,
wherein the gate line corresponding to pixel units in the (2k−1)^{th} row or the gate line corresponding to pixel units in the 2k^{th} row receives the gate scanning signal in a predetermined time period, wherein n is a natural number and k is a natural number which is not less than 1 and not greater than n.

2. The array substrate according to claim 1, wherein the gate lines corresponding to pixel units in the 1^{st} row, the 3^{rd} row, . . . , the (2k−1)^{th} row, . . . , the (2n−1)^{th} row receive the gate scanning signal sequentially in the predetermined time period; and the gate lines corresponding to pixel units in the 2^{nd} row, the 4^{th} row, . . . , the 2k^{th} row, . . . , the 2n^{th} row do not receive the gate scanning signal in the predetermined time period.

3. The array substrate according to claim 1, wherein the gate lines corresponding to pixel units in the 2^{nd} row, the 4^{th} row, . . . , the 2k^{th} row, . . . , the 2n^{th} row receive the gate scanning signal sequentially in the predetermined time period; and the gate lines corresponding to pixel units in the 1^{st} row, the 3^{rd} row, . . . , the (2k−1)^{th} row, . . . , the (2n−1)^{th} row do not receive the gate scanning signal in the predetermined time period.

4. The array substrate according to claim 1, wherein a time length of the predetermined time period is within a range of 1/480˜1/120 s.

5. A 3D display device, wherein the 3D display device comprises the array substrate according to claim 1 and a drive circuit, the drive circuit comprises:
a gate driving circuit, configured to provide the gate scanning signal to the gate line corresponding to pixel units in the (2k−1)^{th} row in the predetermined time period; or provide the gate scanning signal to the gate line corresponding to pixel units in the 2k^{th} row in the predetermined time period.

6. The 3D display device according to claim 5, wherein the gate lines corresponding to pixel units in the 1^{st} row, the 3^{rd} row, . . . , the (2k−1)^{th} row, . . . , the (2n−1)^{th} row receive the gate scanning signal sequentially in the predetermined time period; and the gate lines corresponding to pixel units in the 2^{nd} row, the 4^{th} row, . . . , the 2k^{th} row, . . . , the 2n^{th} row do not receive the gate scanning signal in the predetermined time period.

7. The 3D display device according to claim 5, wherein the gate lines corresponding to pixel units in the 2^{nd} row, the 4^{th} row, . . . , the 2k^{th} row, . . . , the 2n^{th} row receive the gate scanning signal sequentially in the predetermined time period; and the gate lines corresponding to pixel units in the 1^{st} row, the 3^{rd} row, . . . , the (2k−1)^{th} row, . . . , the (2n−1)^{th} row do not receive the gate scanning signal in the predetermined time period.

8. The 3D display device according to claim 5, wherein a time length of the predetermined time period is within a range of 1/480˜1/120 s.

9. A method for driving the 3D display device according to claim 5, wherein the driving method comprises:
transmitting the gate scanning signal to the gate line corresponding to pixel units in the (2k−1)^{th} row in the predetermined time period; or
transmitting the gate scanning signal to a gate line corresponding to pixel units in the 2k^{th} row in the predetermined time period.

10. The method according to claim 9, wherein transmitting the gate scanning signal to the gate line corresponding to pixel units in the (2k−1)^{th} row in the predetermined time period comprises:
transmitting the gate scanning signal to the gate lines corresponding to pixel units in the 1^{st} row, the 3^{rd} row, . . . , the (2k−1)^{th} row, . . . , the (2n−1)^{th} row sequentially in the predetermined time period; not transmitting the gate scanning signal to the gate lines corresponding to pixel units in the 2^{nd} row, the 4^{th} row, . . . , the 2k^{th} row, . . . , the 2n^{th} row sequentially in the predetermined time period.

11. The method according to claim 9, wherein transmitting the gate scanning signal to the gate line corresponding to pixel units in the 2k^{th} row in the predetermined time period comprises:
transmitting the gate scanning signal to the gate lines corresponding to pixel units in the 2^{nd} row, the 4^{th} row, . . . , the 2k^{th} row, . . . , the 2n^{th} row sequentially in the predetermined time period; not transmitting the gate scanning signal to the gate lines corresponding to pixel units in the 1^{st} row, the 3^{rd} row, . . . , the (2k−1)^{th} row, . . . , the (2n−1)^{th} row sequentially in the predetermined time period.

12. The method according to claim 9, wherein a time length of the predetermined time period is within a range of 1/480˜1/120 s.
